(19) United States
(12) Patent Application Publication
(10) Pub. No.: US 2026/0260515 A1
(43) Pub. Date: Sep. 3, 2026

(54) Sharing Images Based On Location History

(71) Applicant: Ikorongo Technology, LLC, Swansboro, NC (US)

(72) Inventors: Hugh Blake Svendsen, Swansboro, NC (US); Eugene Farrelly, Cary, NC (US); Kunal Kandekar, San Ramon, CA (US)

(73) Assignee: Ikorongo Technology, LLC, Swansboro, NC (US)

(21) Appl. No.: 19/659,290

(22) Filed: Apr. 27, 2026

Related U.S. Application Data
(60) Provisional application No. 63/887,666, filed on Sep. 25, 2025.
(60) Provisional application No. 63/915,264, filed on Nov. 11, 2025.
(60) Provisional application No. 64/021,325, filed on Mar. 30, 2026.

(51) Int. Cl. G06V 40/16; G06F 3/01; G06F 3/0482; G06F 21/32; G06V 40/50

(52) U.S. Cl. CPC G06V 40/172; G06F 3/017; G06F 3/0482; G06F 21/32; G06V 40/50

(57) ABSTRACT

One embodiment of a method of operating a first user device to exchange images between the first user device and a second user device, the method comprising: detecting, by the first user device, a proximity gesture between the first user device and the second user device; responsive to the proximity gesture: transmitting, from the first user device to the second user device, a first digest including location history associated with the first user device; receiving, at the first user device, a second digest including location history associated with the second user device transmitted from the second user device; identifying, by the first user device using the second digest, one or more images captured by the first user device based on the second digest; and transmitting, from the first user device to the second user device, the one or more images.

### CROSS-REFERENCE TO RELATED APPLICATIONS

This application claims the benefit of U.S. Provisional Patent Application No. 63/887,666, filed Sep. 25, 2025, U.S. Provisional Patent Application No. 63/915,264, filed Nov. 11, 2025, and U.S. Provisional Patent Application No. 64/021,325, filed Mar. 30, 2026. Each of the foregoing applications is hereby incorporated by reference herein in its entirety.

### BACKGROUND

### Field of the Various Embodiments

The various embodiments relate generally to the sharing of images based on the geographic location of capture.

### Description of the Related Art

Individuals frequently capture images during trips, events, or excursions using mobile devices. In many cases, unrelated individuals may independently capture images at overlapping locations, and such images may incidentally include the other individuals or members of their respective groups (e.g., family members, travel companions). Although these individuals may have no prior relationship and may have no future contact, it may nevertheless be desirable to enable selective sharing of such images.

Conventional image-sharing techniques typically require an established social connection, sharing of account information, a centralized service, or manual file selection and exchange. These approaches are often impractical for ad hoc interactions between unrelated individuals, particularly as people get more concerned with privacy.

As the foregoing illustrates, what is needed are more effective techniques for enabling two users, who may not otherwise know each other, to conveniently and efficiently exchange images of potential relevance, while minimizing user effort and preserving user control over the images that are shared or retained.

### SUMMARY

According to embodiments disclosed herein, systems and methods are provided for facilitating image exchange between devices associated with two users. Each user operates a mobile device capable of capturing and storing images. When the users bring their respective devices into proximity, an exchange process is initiated.

Upon initiation, each device generates and transmits a digest to the other device. The digest includes data describing the user's location history, facial representations of the user, and facial representations of the user's acquaintances (such as members of a group traveling with the user), or any combination thereof. Each receiving device processes the digest to identify images captured by that device that are potentially relevant to the other user, such as images that include the other user, members of the other user's group, or were captured at overlapping locations of interest. The digest can be encrypted such that the receiving device is only able to decrypt matching digest information (such as a location logged on both devices and/or a facial representation occurring in images on both devices).

In some embodiments, the identified images are automatically transmitted between devices without additional user action beyond the initiation gesture. In other embodiments, the transmitting device presents the identified images to its user for confirmation prior to transmission, thereby allowing the user to adjust the set of images to be shared. In further embodiments, the receiving device presents the received images to its user, allowing the user to select which of the received images to retain.

One embodiment of the present disclosure sets forth a method of operating a first user device to exchange images between the first user device and a second user device. The method includes detecting, by the first user device, a proximity gesture between the first user device and the second user device. The method also includes, responsive to the proximity gesture: transmitting, from the first user device to the second user device, a first digest including location history associated with the first user device. The method further includes receiving, at the first user device, a second digest including location history associated with the second user device transmitted from the second user device. The method also includes identifying, by the first user device using the second digest, one or more images captured by the first user device based on the second digest. The method also includes transmitting, from the first user device to the second user device, the one or more images.

At least one technical advantage of the disclosed techniques relative to the prior art is that the disclosed techniques provide mechanisms for sharing images without an established social connection, a centralized service, or manual file selection and exchange. Another technical advantage of the disclosed techniques includes mechanisms for privacy preservation, whereby encrypted digest information is shared between devices, and the receiving devices can decrypt only the portions to which the receiving device already has access.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a system diagram illustrating a system for sharing images, according to one or more embodiments;

FIG. 2 is a block diagram illustrating a structure for representing digest information;

FIG. 3A is a sequence diagram illustrating interactions between two user devices to share images, according to one or more embodiments;

FIG. 3B is a sequence diagram illustrating interactions between two user devices to share images, according to one or more embodiments;

FIG. 3C is a flowchart illustrating the determination of images to share based on location history information included in a digest obtained from a user device, according to one or more embodiments;

FIG. 3D is a flowchart illustrating the determination of images to share based on facial template information included in a digest obtained from a user device, according to one or more embodiments;

FIG. 4A is a graphical depiction of a user interface allowing a user to specify the contents of a digest, according to one or more embodiments;

FIG. 4B is a graphical depiction of a user interface allowing a user to confirm the selected images, according to one or more embodiments;

FIG. 5 is a diagram illustrating the locations visited during an exemplary excursion, according to one or more embodiments;

FIG. 6 is a flow diagram illustrating the sharing of images, according to one or more embodiments;

FIG. 7 is a block diagram illustrating computing device hardware architecture, according to one or more embodiments; and

FIG. 8 is a block diagram illustrating computing device software architecture, according to one or more embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### Definitions

Certain terms are described below to facilitate understanding of the disclosed techniques. The descriptions are intended to provide examples and context for the terms as used in this specification. Unless explicitly stated otherwise, the descriptions should not be interpreted as limiting the scope of the claims.

As used herein, a digest refers to a data structure generated by a user device and transmitted to another user device for purposes of identifying images that may be relevant to the other user. In some embodiments, a digest may include one or more of a time window, location history, facial templates, object embeddings, request preferences, or other data usable to identify potentially relevant images.

As used herein, candidate images refer to one or more images identified as matching one or more digest parameters, but that have not yet undergone any required ranking, filtering, confirmation, retention selection, or other final disposition at a sending user device and/or a receiving user device. Once a candidate image is retained at a receiving user device, the image may be referred to as a retained image.

As used herein, location history refers to data indicating geographic locations visited by a user device over time. In some embodiments, the location history may comprise a plurality of geographic locations, each associated with a corresponding timestamp indicating when the location was visited. In some embodiments, the location history included in a digest may correspond to a subset of a master location history selected according to a time window or other criteria.

As used herein, a facial template refers to a mathematical representation of facial features derived from image data and usable for comparison with other facial templates. A facial template may correspond to a user, a member of a user's group, or another subject appearing in one or more images. Matching facial templates can indicate that two templates correspond to the same subject without requiring that the subject be expressly identified by name.

As used herein, request preferences refer to parameters provided by a requesting user device to influence identification, filtering, ranking, formatting, and/or return of images by a responding user device. In some embodiments, request preferences may include one or more of a maximum number of images to return, relative weighting of location-based and/or face-based matching information, image size restrictions, format restrictions, or other constraints on returned images.

As used herein, a proximity gesture refers to one or more signals indicating that a sharing process is to be initiated between two user devices. In some embodiments, a proximity gesture may include bringing two user devices into close geographic or physical proximity, detecting another user device through a short-range wireless interface, scanning a code, selecting another user device from a displayed control, or otherwise providing input indicating that image sharing is to be initiated.

As used herein, a proximate location refers to a location determined to correspond to geographic proximity between two user devices at substantially the same time. In some embodiments, a proximate location may be determined based on comparing location samples from two user devices, determining that the corresponding timestamps satisfy a time-separation criterion, determining that the corresponding geographic locations satisfy a distance criterion, and optionally determining a midpoint or other representative location associated with the matched locations.

As used herein, a proximate image refers to an image determined to have been captured within a threshold spatial and/or temporal relationship to a proximate location. In some embodiments, proximate images may be identified by comparing a capture location of an image with a midpoint or other representative location associated with a proximate location and determining that the image was captured within a threshold distance and, in some embodiments, within a threshold time of the proximate location.

Additional terms may be described elsewhere in this specification in the context of particular embodiments.

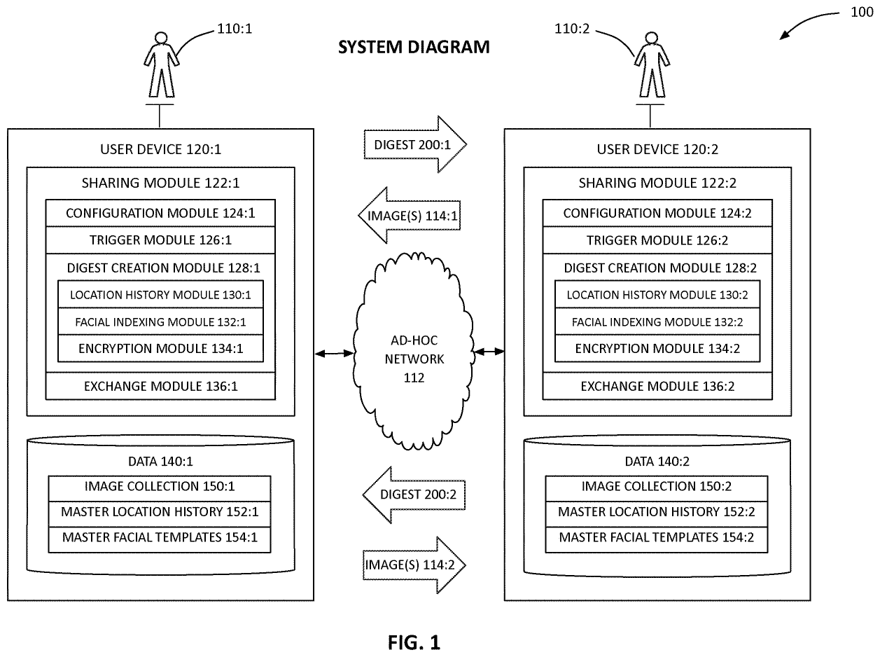

FIG. 1 is a system diagram illustrating a system 100 for sharing images, according to one or more embodiments. The system 100 includes two user devices 120 associated with users 110 communicatively coupled through an ad-hoc network 112. The user device 120 includes a sharing module 122 operable to share candidate images 114 based on digest 200 information. As used herein, candidate images 114 are one or more images that match the digest 200 parameters, but have not yet undergone ranking and/or confirmation by either the sending user device 120 (when required) and/or the receiving user device 120 (when required). Once candidate images are retained at the receiving device in non-volatile memory, they are referred to as retained images. The digest 200 includes data describing the user's location history, facial representations of the user, facial representations of subjects known to the user (such as members of a group traveling with the user 110 or subjects appearing in the image collection 150 associated with the user), or any combination thereof. The sharing module 122 includes a configuration module 124, trigger module 126, digest creation module 128, exchange module 136, and associated data 140.

The configuration module 124 handles the initialization and configuration of the sharing module 122 based on preference data. An example of preference data includes a time window that controls the time duration for which location history and/or facial representation data are included in the digest 200. The time window typically starts at an earlier time and ends at the current time.

The trigger module 126 detects proximity gestures. As used herein, a proximity gesture is any one or more signals received by a user device 120 indicating that the user device 120 is to initiate a sharing process to exchange candidate images 114 based on digest 200 data with another user device. One example of a proximity gesture includes the detection at a user device 120:1 that it has been brought into close geographical or physical proximity to another user device 120:2. Another example would include a user 110:1 of a first user device 120:1 selecting another user device 120:2 from a control displayed on the display of the first user device 120:1. Upon detecting a proximity gesture, the trigger module 126 signals the exchange module 136 to couple to the other user device 120:2 and initiate sending (transmitting) digest 200 and receiving one or more candidate images 114.

The digest creation module 128 constructs (builds) a digest 200 using the location history module 130, the facial indexing module 132, and the encryption module 134. The location history module 130 constructs the location-history portion of the digest 200 using the master location history 152. The facial indexing module 132 constructs the facial-template portion of the digest 200 using the master facial templates 154. The encryption module 134 encrypts the location-history portion and/or the facial-template portion of the digest using one or more encryption algorithms to provide privacy. The digest creation module 128 is used by the exchange module 136 to build the digest 200, which is subsequently sent to other user devices 120.

The exchange module 136, when invoked by the trigger module 126, handles the networking aspects of sending the digest 200:1 from user device 120:1 to another user device 120:2, and the subsequent receipt of one or more candidate images 114:1 from the other user device 120:2 based on the received digest 200:1.

The transfer of digest 200 data and candidate image 114 data between the two user devices 120 is typically bidirectional, meaning that both user devices 120 send digest 200 data and candidate image 114 data; however, this need not be the case. In some instances, only one device sends digest 200 data and receives candidate image 114 data. Note that both user devices 120 are still required to complete the operation.

Data 140 includes data operated on by the sharing module 122. Data 140 includes image collection 150, master location history 152, and master facial templates 154. The image collection 150 includes one or more images captured by the user device 120. In some embodiments, the user device 120 is an iPhone or Android phone, and the images in the image collection 150 are captured using the integrated cameras available on the respective phones. The master location history 152 includes a plurality of timestamped geographical location points determined by a user device 120 as the user device 120 operates and is physically transported to new geographic locations by the user 110. The master facial templates 154 store facial templates associated with faces occurring in the image collection 150 and, in some embodiments, an index linking the facial templates to corresponding images in the image collection 150.

### Storing Capture Location in an Image

In some embodiments, the digital image files stored in the image collection 150 include metadata stored in accordance with the Exchangeable Image File Format (EXIF) standard. The EXIF structure employs a tag-based system in which each tag corresponds to a predefined field. Within the EXIF specification, a dedicated GPS Image File Directory (GPS IFD) is defined for storing geolocation information associated with the image capture.

The GPS IFD may contain a plurality of fields that collectively specify the geographic location at which the image was captured. These fields typically include, but are not limited to:

| FIELD | DESCRIPTION |
|---|---|
| GPSLatitude | a numerical value representing the latitude of the capture |
| | location, typically encoded as a set of three rational |
| | numbers corresponding to degrees, minutes, and seconds |
| GPSLatitudeRef | a character value indicating whether the latitude is north |
| | (N) or south (S) of the equator |
| GPSLongitude | a numerical value representing the longitude of the |
| | capture location, typically encoded as degrees, minutes, |
| | and seconds in rational form |
| GPSLongitudeRef | a character value indicating whether the longitude is east |
| | (E) or west (W) of the prime meridian |
| GPSAltitude | a numerical value representing the altitude relative to sea |
| | level, expressed in meters |
| GPSAltitudeRef | a value designating whether the altitude is above or below |
| | sea level |
| GPSTimeStamp and | values identifying the Coordinated Universal Time (UTC) |
| GPSDateStamp | and date at which the GPS fix was obtained |
| GPSProcessingMethod | a string describing the method by which the position was |
| | determined (for example, “GPS,” “CELLID,” or “WLAN”) |

Each of the foregoing values is typically encoded as a rational number, meaning that the value is represented by a pair of integers corresponding to a numerator and denominator. For example, the latitude component of 35 degrees, 12 minutes, and 30.48 seconds may be encoded as the sequence 35/1, 12/1, and 3048/100. The EXIF header further specifies the byte order (big-endian or little-endian) to ensure proper interpretation of the encoded values.

When the image is subsequently accessed, compliant applications may extract the GPS IFD fields, convert the rational values into decimal coordinates, and render the capture location on a map display. In the absence of valid GPS information, the GPS IFD may be omitted or only partially populated.

While the present disclosure is described primarily in terms of sharing images, the techniques described are not limited thereto. The disclosed techniques also apply to other media item types such as text, audio, and video. Each of these media types can be tagged with a geographical location of capture/creation. With video, the individual frames can be treated as a whole or as individual images (where each frame has a timestamped geolocation).

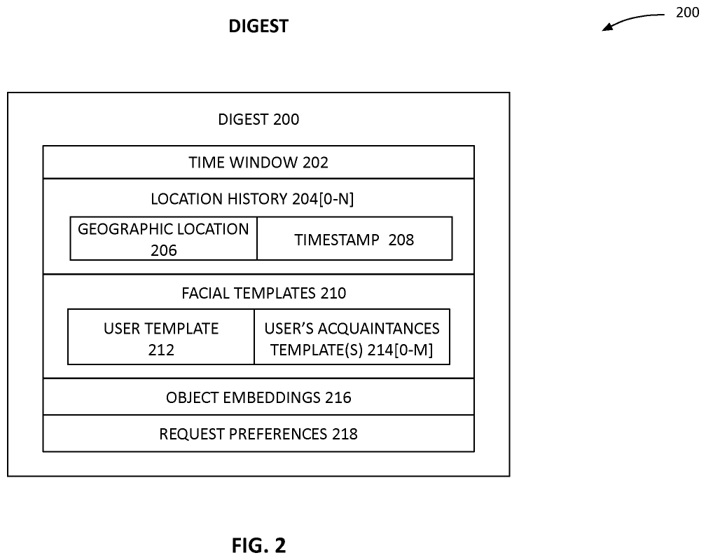

FIG. 2 is a block diagram illustrating a structure for representing digest 200 information. The digest 200 includes a time window 202, location history 204, facial templates 210, object embeddings 216, and request preferences 218. The digest 200 structure is shared with other user devices 120 to enable image exchange.

The time window 202 identifies a time period covered by a digest 200. The time window 202 has a start time and an end time. By default, the time window 202 covers a 24-hour period ending with the current time. The user 110 can change the time window 202.

The location history 204 comprises the geographic locations visited by the user 110 with a user device 120 during the time window 202. The location history 204 is taken from the master location history 152 based on the time window 202. Each geographic location 206 is timestamped 208, identifying the time at which the geographic location 206 was visited. In some embodiments, the geographic location 206 is stored using GPS coordinates.

The facial templates 210 comprise one or more facial templates taken from the master facial templates 154. The facial templates 210 include a facial template for the user 110 (user template 212) and facial templates of subjects (people) in the user's group (user acquaintance templates 214). The user's group includes other subjects associated with the user 110, for example, other subjects that may be traveling with user 110. In some embodiments, the facial templates 210 are a subset of the master facial templates 154 based on the time window 202. In some embodiments, the facial templates 210 include all or substantially all of the master facial templates 154.

Object embeddings 216 store information identifying other objects appearing in images represented by a digest 200. Image-processing techniques can be used to recognize, detect, classify, segment, or otherwise identify objects and scene elements appearing within captured images. Such recognizable content may include, for example, animals, vehicles, buildings, landmarks, roads, signage, furniture, products, food items, text-bearing objects, natural features, and other discernible objects or regions depicted in an image. In some embodiments, the identified content may further include contextual or semantic scene information, such as whether an image depicts a beach, mountain, city street, interior room, park, or other environment. The system may also determine attributes associated with recognized content, such as type, position, size, count, prominence, motion, or relationships among detected elements.

The request preferences 218 pass parameters from the requesting user device 120:1 to the responding user device 120:2. The parameters can include the maximum number of images to return, weights to apply to facial templates, weights to apply to locations in the location history, size restrictions on the images to return (e.g., don't return panoramic images if too large), and format preferences (e.g., return only .jpeg images).

In various embodiments, the facial indexing module 132 employs a facial recognition (or matching) system which operates by generating and processing mathematical representations of facial features derived from one or more digital images of a subject. Rather than storing or comparing raw image data, the system extracts a set of facial feature descriptors that uniquely characterize the spatial and textural attributes of a person's face. These descriptors may collectively define a facial feature vector, face embedding, or face template, depending on the implementation.

During an enrollment phase, a facial image of a user may be acquired using a camera or imaging device (ideally but optionally under standardized lighting and orientation conditions). The captured image is optionally pre-processed to perform one or more operations such as face detection, alignment of facial landmarks (e.g., eyes, nose, mouth), normalization of color and illumination, and resizing to a fixed resolution. The resulting normalized image is then provided to a feature extraction model, such as a convolutional neural network (CNN) trained for facial identification. The model outputs a numerical representation of the face in the form of a high-dimensional vector (e.g., 128-512 floating-point elements), where each element corresponds to a learned feature of the subject's face.

The system may normalize the resulting feature vector using, for example, L2 normalization to produce a standardized facial template. The template may be stored, transmitted, or compared to other templates to perform verification or identification. Two templates associated with the same subject are expected to exhibit a small distance within the embedding space, as determined by a similarity metric such as cosine similarity or Euclidean distance.

To ensure interoperability and data security, the facial template may conform to established biometric data interchange standards. In some implementations, the template is encoded according to ISO/IEC 19794:19 (Face Recognition Format for Data Interchange) or the ANSI/NIST ITL:1 Type:17 record structure. Such standards define the data fields, dimensionality, quantization, normalization method, and associated metadata for the stored or transmitted template. For example, a template record may include identifiers for the algorithm vendor, the capture device, the feature vector length, and a quality score associated with the capture. Earlier standards such as ISO/IEC 19794-5 define requirements for the acquisition and formatting of face images prior to feature extraction.

Note that, as used herein, the matching of subjects does not require actual facial recognition. A digest can be populated with facial templates (numerical representations of the facial appearance of subjects in images). As used herein, a subject refers to a person (human). Matching two templates identifies that the two templates refer to the same subject (within a matching probability threshold). However, the subject need not be identified for this matching to take place. All users 110 are subjects (i.e all users are people), but not all subjects have to be users 110 (i.e. some people will appear in images but are not taking images and/or using an image application employing an exchange module). Note that subjects that appear in an image but do not match a face template in the digest are ignored in terms of generating a matching score.

A user 110 may be interested in only sharing relevant master location history 152 to avoid sharing information that is irrelevant to the matching process, or information that should be kept private. For instance, a user 110 may only wish to share images or information related to locations they visited that the other user 110:2 has also visited. To this end, techniques are required such that only the relevant, common, master location history 152 is exchanged across user devices 120. In one embodiment, each user 110 can manually select which locations from the location history to exchange with the other user's 110:2 user device 120:2. This manual selection, however, can get cumbersome. Hence, other approaches based on cryptographic technologies can be used to share only common locations.

To this end, the encryption module 134 employs techniques such as Private Set Intersection (PSI), Zero-Knowledge Proofs (ZKP), and/or Homomorphic Encryption. In some embodiments, the private set intersection approach could be used. Here, each set is the set of distinct locations from each user's 110 master location history 152. Then each of these sets is encrypted on its respective user device 120 and exchanged with the other user device 120:2 using PSI or ZKP techniques. Each user device 120 then computes the intersection of the encrypted set, which ensures that each user device 120 can only decrypt entries in the other user's 120:2 encrypted set where the location is the same, thus only revealing the common entries in each set to each user 110. These common location entries can then be used to filter the set of images to be shared with the other user device. In another embodiment, Zero Knowledge Proofs can be used, which ensure that each party only reveals that they possess some information (an “answer”) without revealing any other information. In this case, the solution is modeled such that each individual location is an “answer” for a zero-knowledge proof, and each user device 120 can only reveal the location it has already been at.

The granularity of these locations could be selected based on approximate matching, e.g. at the level of a city or a given geographic range. Finer-grained matching could be performed if a coarse location match is found over subsequent iterations of the same process. Alternatively, a Distance-Aware Private Set Intersection approach could be used, which can allow revealing locations within a given range by embedding the locations in a metric space and sharing those.

Note that date and time information may also be encoded along with each location in the set, potentially based on user indication or configuration, such that only entries in the set with coincident locations as well as time would match, to ensure that only location information where both users were present at substantially the same time is revealed to each user.

Similarly, facial representation information may also be similarly encoded in the encrypted sets (along with location history information or by itself) that are exchanged, and matching may be performed on the basis including the facial representation information. In other embodiments, other relevant information extracted from the images, such as visual fingerprints, AI-generated labels, or embeddings generated by computer vision models, could also be encoded in the encrypted digests.

In some embodiments, the facial representation information is encrypted using a technique optimized for challenges posed by floating-point vectors and cosine similarity techniques used to compare facial data. One such technique is described in Hyunjung Son, Seunghun Paik, Yunki Kim, Sunpill Kim, Heewon Chung, and Jae Hong Seo, “Doubly Efficient Fuzzy Private Set Intersection for High-dimensional Data with Cosine Similarity,” Cryptology ePrint Archive, Paper 2025/054 (2025), which is hereby incorporated by reference herein in its entirety as nonessential material. In some embodiments, facial representation information is generated by a feature extraction model as high-dimensional floating-point vectors, each vector representing a face in a continuous embedding space. Because direct encryption of floating-point values is incompatible with conventional secure matching techniques, the vectors are first transformed into a form suitable for privacy-preserving similarity evaluation. In one embodiment, the floating-point vectors are normalized and encoded such that cosine similarity between vectors can be approximated through algebraic operations supported by the encryption scheme. Each party encrypts its encoded facial representation vectors using a cryptographic protocol that enables computation on encrypted data such that inner products or similarity scores can be evaluated without revealing the underlying floating-point values.

A secure matching protocol is then executed between computing devices, wherein encrypted facial representation vectors are compared, and a match result is produced only when the similarity between vectors exceeds a predefined threshold. The protocol is constructed such that neither party can recover the plaintext vectors of the other, and no information beyond the match outcome is disclosed. This approach enables privacy-preserving face matching for floating-point facial representations, which cannot be efficiently supported by exact-match encryption techniques designed for discrete or integer data.

In other embodiments, this process may be continuously performed by user devices without an explicit user gesture to initiate it. Hence as devices detect each other in physical proximity, they may exchange these encrypted digests and perform matching automatically. If matches are found, the devices may notify their users about the availability of relevant images, after which they can manually initiate an image sharing process. In yet another embodiment, some or all of the matching images may even be shared automatically based on user configuration.

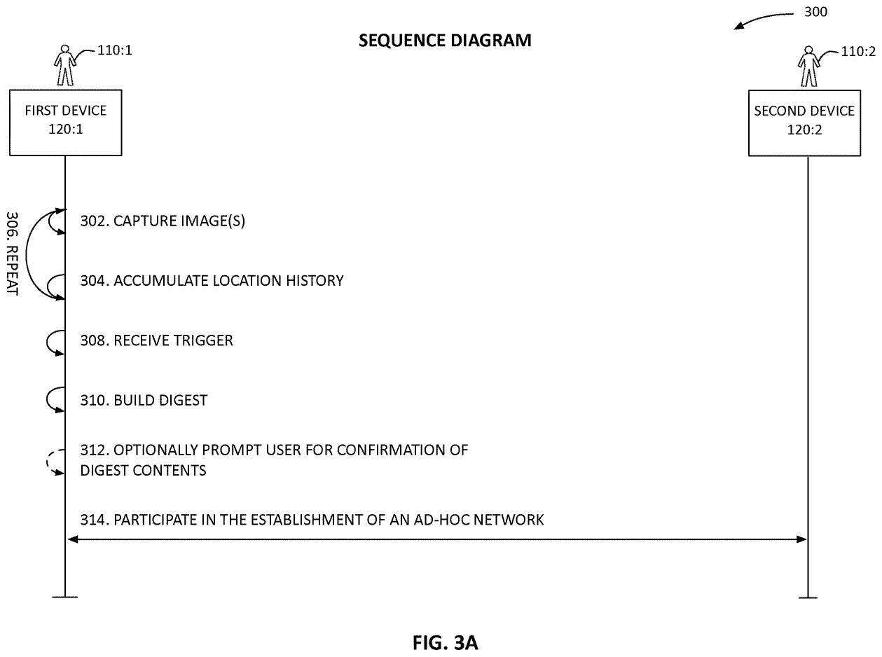

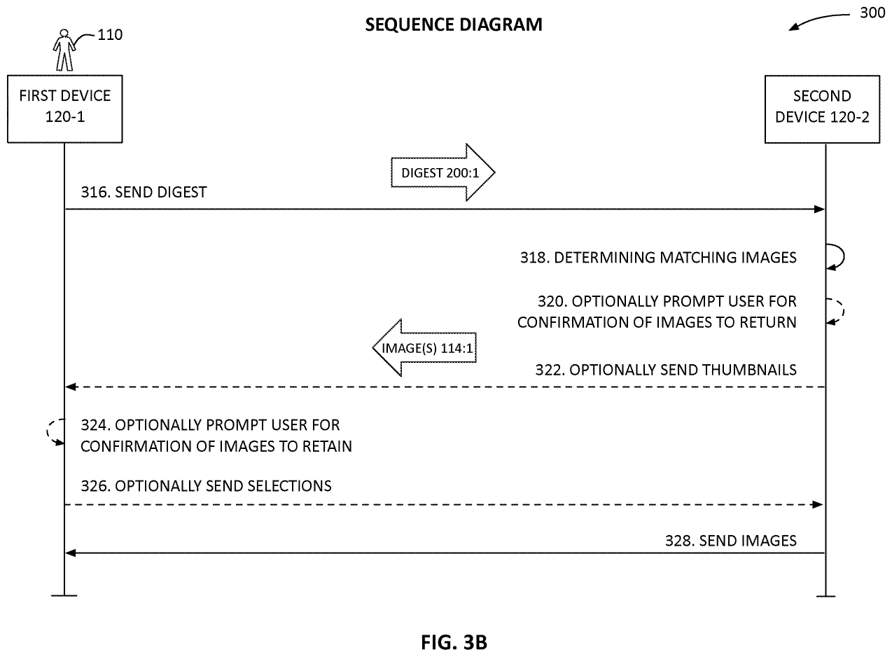

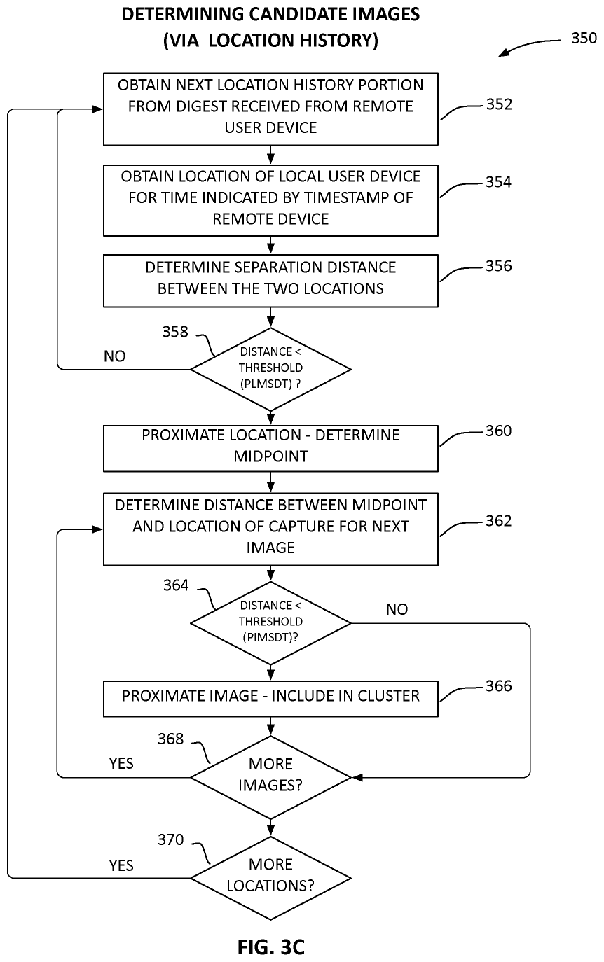

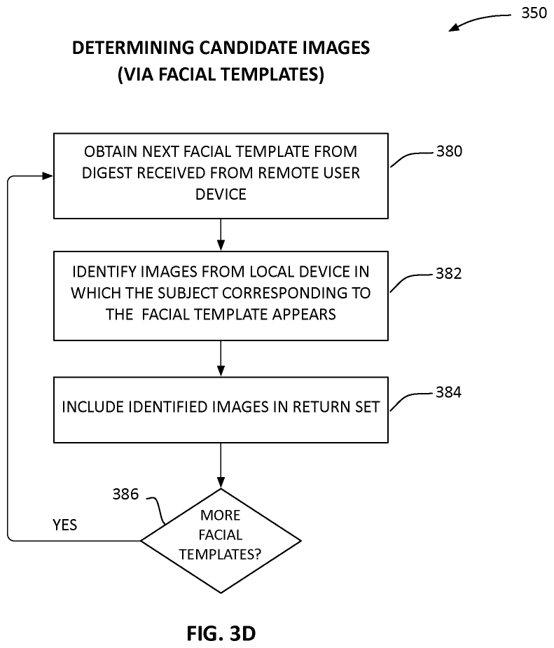

FIG. 3A is a sequence diagram illustrating interactions between two user devices to share images, according to one or more embodiments.

At step 302, the user device 120:1 captures images and stores the information in the image collection 150:1. The images are tagged with location information identifying the geographic location of capture.

At step 304, the user device 120:1 accumulates (collects) geographic location 206:1 data and stores the information in the master location history 152:1. The geographic location 206:1 data is timestamped 208:1 to identify the time the location was visited.

At step 306, the process of capturing images and collecting location data can be repeated any number of times as the user 110:1 of the user device 120:1 moves about geographically and continues to capture images using the user device 120:1.

At step 308, the trigger module 126:1 of the sharing module 122:1 detects the occurrence of a trigger, indicating that the user 110:1 of the user device 120:1 wants to share images with another user device 120:2. In some embodiments, a trigger can take the form of physically bringing the two user devices 120 very close together. For example, with NFC, the two devices need to be within a few centimeters for proximity and exchange of identification information (about an inch or two), but don't actually need to touch. In some embodiments, QR codes can be used to initiate pairing between user devices 120. In some embodiments, a user device can initiate a sharing action, and one or more potential recipient user devices are automatically populated in the initiating device's display.

At step 310, the digest creation module 128:1 of the sharing module 122:1 constructs a digest 200:1 for the user device 120:1. The digest 200:1 includes data describing the user's location history, a facial representation of the user, zero or more facial representations of zero or more members of a group traveling with the user 110:1, or any combination thereof. In some embodiments, only the location history 204:1 is included in the digest 200:1. In some embodiments, only facial templates 210:1 are included in the digest 200:1. In some embodiments, the creation of the digest 200:1 is implemented by an embedded AI module residing on the user device 120:1.

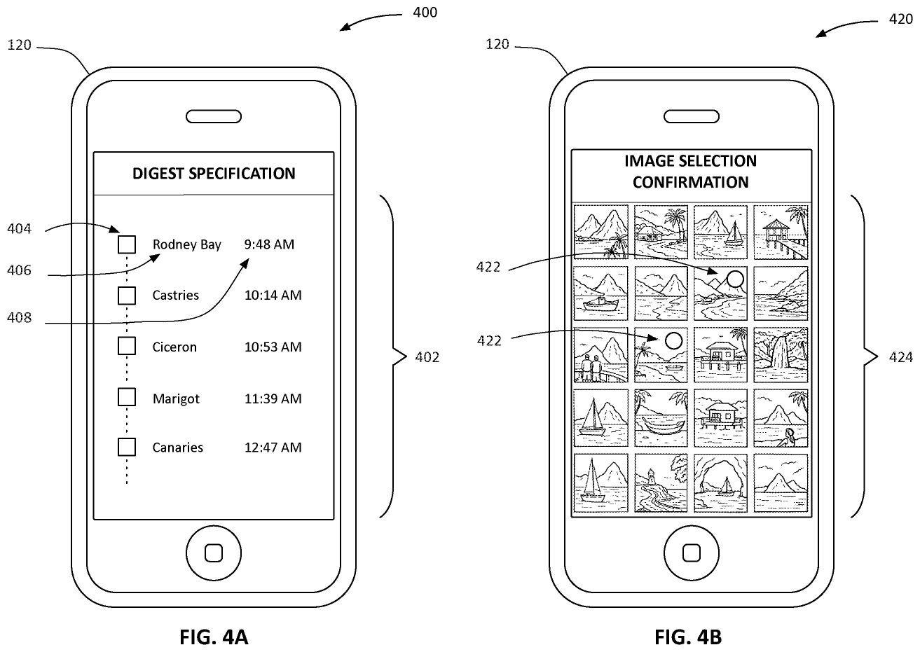

At step 312, the sharing module 122 optionally prompts the user 110:1 of the user device 120:1 for confirmation of the contents of the digest 200:1 as well as the request preferences 218:1. At this step, the user can provide user input to the sharing module 122:1, adjusting the time window 202:1 of the digest, indicating which portions (location history 204:1 and/or facial templates 210:1) to include in the digest 200:1, and adjusting the request preferences 218:1. In some embodiments, the editing of the digest 200:1 is aided by the user interface shown in FIG. 4A.

At step 314, the first user device 120:1 causes, or participates in, establishment of an ad hoc network 112 coupling the first user device 120:1 to the second user device 120:2. In some embodiments, the system 100 employs multiple communication layers to establish the ad hoc network 112. For example, near-field communication (NFC) may be used for proximity detection and exchange of metadata sufficient to initiate trust and discovery, Bluetooth Low Energy (BLE) may be used for session initiation and authentication, and a Wi-Fi Direct protocol, such as AWDL, may be used for secure data transfer. In this manner, the system 100 can provide efficient, user-controlled exchange of information between the user devices 120.

In a representative embodiment, when two user devices 120 (two iPhone devices, for example) are positioned in close physical proximity, a near-field communication (NFC) interface may be employed to detect the relative positioning of the devices and initiate a data exchange session. Upon initiation, a short-range wireless protocol, such as Bluetooth Low Energy (BLE), may be used to establish initial device discovery and perform a handshake operation. During this handshake, cryptographic operations may be performed to authenticate the devices and to generate one or more encryption keys to secure subsequent transmissions. Once the handshake is complete, the devices may transition to a peer-to-peer wireless communication channel, such as one established via Apple Wireless Direct Link (AWDL) over a Wi-Fi radio, in order to support higher throughput and reduced latency. Information such as digests 200 and candidate images 114 may then be transferred via the peer-to-peer channel under end-to-end encryption. In some embodiments, a user interface may be presented requiring affirmative user consent (e.g., selecting a “share” or “receive only” control element) prior to transfer of a digest 200, candidate images 114, retained images, or any combination thereof. In alternative implementations, if the higher-bandwidth peer-to-peer channel is unavailable, the system may revert to the lower-bandwidth BLE channel for data transfer.

In some embodiments, when two Android user devices 120 are positioned in close physical proximity, a near-field communication (NFC) interface is activated to detect proximity and to initiate a data exchange session. The initiating user device 120 writes, via an NFC data exchange format (NDEF) record, a session token comprising a transient identifier and transport parameters (e.g., supported radios and cipher suites). In response, the user devices 120 perform short-range discovery using Bluetooth Low Energy (BLE) advertisements to mutually resolve the session token and to establish an initial control link. During this phase, the user devices 120 execute a cryptographic handshake, such as an Elliptic-Curve Diffie-Hellman (ECDH) key agreement with ephemeral keys, to derive one or more session keys. Upon successful authentication, the user devices 120 transition to a peer-to-peer high-bandwidth data path selected from Wi-Fi Direct (including Group Owner negotiation), Wi-Fi Aware/Neighbor Awareness Networking (NAN) with a data path (NDP), or, in constrained cases, a BLE GATT data channel. Digest 200 information, candidate images 114, retained images, or any combination thereof may then be transmitted over the selected data path under transport-layer security (e.g., TLS over Wi-Fi Direct or DTLS over NAN), while a user interface on one or both user devices 120 solicits explicit user consent (e.g., “share” versus “receive only”) prior to transmission. If the higher-bandwidth data path cannot be established, the system reverts to a BLE-only transfer using the previously derived session keys. The foregoing enables NFC for proximity detection and rendezvous, BLE for discovery and control, and a Wi-Fi peer-to-peer transport for efficient, encrypted exchange of digest information and image data.

In some embodiments, cross-platform interoperability is desired, capable of supporting any device (for example, if either side insists on upgrading to AWDL instead of Wi-Fi Direct/Aware). Cross-platform interoperability can be achieved by defining a compatibility profile that (i) uses NFC/NDEF only to convey a short rendezvous token, (ii) performs discovery, pairing, and key agreement over BLE (e.g., ECDH), and (iii) keeps the payload on BLE GATT when a mutually supported Wi-Fi data path is unavailable. In another embodiment, when both user devices 120 support a common Wi-Fi peer technology, the system selects that path; however, where the first user devices 120 exposes only AWDL and the second exposes only Wi-Fi Direct or Wi-Fi Aware, the method reverts to the BLE transport to preserve interoperability. In still another embodiment, the user interface gates transfer on affirmative consent, and session keys derived during the BLE handshake protect the BLE payload with application-layer encryption. (Background: AWDL is Apple-proprietary and documented primarily via reverse-engineering; Android exposes Wi-Fi Direct and Wi-Fi Aware in public APIs.)

As used herein, the term “infrastructure Wi-Fi” refers to a wireless networking configuration in which one or more client user devices 120 communicate with each other through a centralized access point (AP) or router that manages network associations, authentication, and routing of packets between user devices 120 and/or to an external network (e.g., the Internet). In an infrastructure mode, the AP functions as a coordination entity maintaining a Basic Service Set (BSS) that defines network identifiers (SSID/BSSID), authentication keys, and timing synchronization parameters. Each client station (STA) associates with the AP before transmitting data to another user device 120 on the network. Accordingly, all inter-device communication within the infrastructure network passes through the AP, even when the destination user device 120 is another local client.

As used herein, the term “Wi-Fi Direct” refers to a peer-to-peer (P2P) wireless communication mode standardized under the Wi-Fi Alliance's Wi-Fi Peer-to-Peer (P2P) specification, in which user devices 120 communicate directly with one another without requiring an intermediary access point. In a Wi-Fi Direct session, one participating user device 120 temporarily assumes the role of a Group Owner (GO)—functionally similar to an access point—while one or more client user devices 120 associate directly with that GO to form an ad hoc P2P Group. The group is created dynamically, and the user devices 120 negotiate the GO role through a peer discovery and provisioning process (e.g., via Wi-Fi Protected Setup). Data is then exchanged directly between user devices 120 within the group, without traversing a fixed infrastructure.

Infrastructure Wi-Fi and Wi-Fi Direct operate according to fundamentally different network topologies. Infrastructure Wi-Fi requires a fixed access point that manages associations, routing, authentication, and timing for all connected user devices 120, such that all communications are relayed through the access point. In contrast, Wi-Fi Direct creates a transient, peer-to-peer network in which user devices 120 communicate directly with one another without involvement of an access point, and in which a temporary Group Owner is elected solely for coordinating that ad-hoc session. These two modes therefore differ not only in how user devices 120 discover and associate with one another, but also in how data is routed, who controls the network, and whether an external infrastructure is required. As described herein, the ad hoc network 112 of system 100 does not use infrastructure Wi-Fi.

FIG. 3B is a sequence diagram illustrating interactions between two user devices to share images, according to one or more embodiments. FIG. 3B is a continuation of FIG. 3A, picking up where FIG. 3A leaves off.

At step 316, the sharing module 122:1 transmits the digest 200:1 from user device 120:1 to user device 120:2. The transmission is sent through ad-hoc network 112. In some embodiments, the transmission takes place over Wi-Fi Direct.

At step 318, the sharing module 122:2 determines the candidate images 114:1 based on the received digest 200:1. The candidate images 114:1 are identified by determining one or more times during which the user device 120:1 and the other user device 120:2 were in the same geographic locations and identifying one or more images that were captured by the other user device 120:2 during the one or more times. In some embodiments, the facial templates 210:1 of the digest 200:1 can be used to further rank the candidate images in the image collection 150:2 based on the request preferences 218:1. In some embodiments, the logic of step 318 is implemented as shown in FIG. 3C, as shown in FIG. 3D, or a combination thereof. In some embodiments, the logic of step 318 is implemented by an embedded AI module residing on the user device 120:2.

At step 320, the sharing module 122:2 optionally prompts the user 110:2 of the other user device 120:2 to confirm which candidate images are to be returned to the user device 120:1. The user 110:2 of the other user device 120:2 can provide user inputs to the sharing module 122:2 of the other user device 120:2 blocking one or more of the candidate images 114 from being returned to the user device 120:1.

At step 322, the sharing module 122:2 of the other user device 120:2 optionally transmits one or more thumbnail images to the user device 120:1. Sending thumbnail images rather than full-resolution images reduces the amount of data transferred, thereby reducing transmission time.

At step 324, the sharing module 122:1 on the user device 120:1 receives the candidate images 114:1 and, optionally, prompts the user 110:1 to confirm which image(s) 114:1 should be retained at the user device 120:1 in the image collection 150:1. In some embodiments, the confirmation of the candidate images 114 to retain is aided by the user interface shown in FIG. 4B. In some embodiments, an embedded AI module residing on the user device 120:1 determines which candidate images 114:1 to keep based on comparing the received candidate images 114:1 to the images already stored in image collection 150:1 and keeping the “best images”. As used herein, best images refer to a combination of quality, uniqueness, and size. Quality refers to attributes like resolution and focus. Uniqueness refers to a preference for scenes not already present in the image collection, 150:1. Size refers to a preference for images that require less storage and transmission time.

At step 326, the sharing module 122:1 of the user device 120:1 optionally sends, based on the thumbnail candidate images, selection information identifying which full-resolution candidate images are to be transmitted by the other user device 120:2 and received and retained at the user device 120:1.

At step 328, the sharing module 122:2 of the other user device 120:2 transmits one or more images to the user device 120:1. The transmission is sent through the ad-hoc network 112 using Wi-Fi Direct.

FIG. 3C is a flowchart illustrating the determination of candidate images 114 to share based on location history information included in a digest 200 obtained from a user device 120, according to one or more embodiments. The sequence diagram of FIG. 3C expands on the steps performed in step 318 of FIG. 3B. As such, FIG. 3C describes processing the digest 200:1 received from user device 120:1 and comparing it with images residing on user device 120:2. The steps performed are described from the perspective of the exchange module 136:2 of user device 120:2. In this example, user device 120:2 is considered the local user device, and user device 120:1 is considered the remote user device.

At a high level, the steps performed in FIG. 3C can be broken into two parts. In the first part, steps 352-358 and 370, the exchange module 136:2 determines zero or more geographic locations that the two user devices 120:1-2 simultaneously visited (proximate locations). In the second part, steps 354-368, the exchange module 136:2 determines zero or more images captured by user device 120:2 at a proximate location (proximate images) for each of the proximate locations. In some scenarios, the proximate locations abut one another to form a single continuous time period. In other scenarios, the proximate locations may not overlap (forming two or more non-overlapping time periods).

At step 352, the exchange module 136:2 of user device 120:2 obtains the next location history 204:1 item from digest 200:1 of user device 120:1. The location history 204:1 includes one or more items that are cycled through in FIG. 3C. The location history 204:1 includes a geographic location 206:1 and a timestamp 208:1 indicating when user device 120:1 was at the geographic location 206:1.

At step 354, the exchange module 136:2 of the user device 120:2 obtains the geographic location 206:2 of the user device 120:2 corresponding to, or otherwise usable for comparison with, the timestamp 208:1 associated with the geographic location 206:1 obtained from the digest 200:1. In some embodiments, the exchange module 136:2 accesses location information for user device 120:2 from the master location history 152. In some embodiments, the exchange module 136:2 accesses location information for user device 120:2 from a digest 200:2 associated with user device 120:2, for example where the digest 200:2 includes location history suitable for comparison with the timestamp 208:1 and/or the geographic location 206:1. Accordingly, the local location history used for comparison at step 354 may be obtained from the master location history 152 or, in some embodiments, from the digest 200:2, and need not require that the time window 202 of digest 200:2 exactly match or overlap the time window 202 of digest 200:1.

The exchange module 136:2 determines that two geographic locations were captured at the same time by comparing the time separation between the timestamps 208 of two user devices 120 to a maximum time separation threshold. If the time separation is less than the maximum time separation threshold, then the location samples are considered to match. In some embodiments, the maximum time separation threshold can be 30 seconds to 5 minutes, inclusive.

In some embodiments, all geographical location sampling is performed at pre-described times, so timestamps 208 are captured simultaneously across all user devices 120, thereby easing the comparison of locations at a given time. For example, the geographical location is sampled periodically (for example, every few seconds to tens of seconds) regardless of whether the user device 120 has moved geographical position. In some embodiments, when timestamping is not coordinated across user devices 120 and/or when a timestamp 208 is missing, interpolation may be used to determine a geographic location for a time between two known times/locations, thereby providing a timestamp 208 for comparison.

In practice, in modern mobile computing systems, the determination of a geographic location of a device is typically performed in a dynamic and context-dependent manner rather than at fixed spatial or temporal intervals. Location sampling may be initiated or adjusted based on one or more detected changes in device state, including, for example, movement of the device, changes in velocity or acceleration, transitions between motion states, execution of one or more applications, variations in signal quality, or confidence levels associated with positioning signals obtained from satellite-based positioning systems, wireless local area networks, cellular networks, or onboard sensors. The resulting location information may be selectively recorded, filtered, clustered, or downsampled to represent significant changes in device position while reducing power consumption, storage requirements, and computational overhead.

At step 356, the exchange module 136:2 of the user device 120:2 determines the separation distance between the two geographic locations 206 identified in steps 352 and 354, which represent the two user devices 120. In some embodiments, the distance between the first and second geographic locations 206 is determined using a planar approximation that treats the geographic coordinates as lying on a substantially flat surface. The planar distance approximation is computationally efficient and can be used when the separation distance between the geographic locations is relatively small or when minor spatial error is acceptable.

In some embodiments, the distance between the first geographic location 206 and the second geographic location 206 is determined using a spherical Earth model that accounts for the Earth's curvature. In one implementation, a great-circle distance is computed using a haversine-based formulation or an equivalent trigonometric method, resulting in a distance corresponding to a shortest path along the Earth's surface between the two geographic locations 206. This spherical distance determination may be used when higher accuracy is required, when the geographic locations are separated by larger distances, or when locations are near polar regions or longitudinal discontinuities.

In some embodiments, the exchange module 136 selects between the planar distance approximation and the spherical distance determination based on one or more of: a separation distance between the geographic locations; a latitude associated with one or both geographic locations; a required accuracy level; user or system-supplied configuration parameters; and available computational resources.

At step 358, the exchange module 136:2 of the user device 120:2 compares the separation distance between the first device and the second device to a proximate location maximum separation distance threshold (PLMSDT). If the separation distance is less than the maximum separation distance threshold, then the two geographic locations are considered to match, and processing continues at step 360; otherwise, processing continues at step 352. In some embodiments, the proximate location maximum distance separation threshold ranges from 100 feet to 1 mile, inclusive.

At step 360, the exchange module 136:2 of the user device 120:2, having

determined that the two geographical locations are sufficiently close to be considered proximate locations, determines the midpoint between the proximate locations.

At step 362, the exchange module 136:2 of the user device 120:2 determines the distance between the midpoint from step 360 and the capture location for the next image to be considered. The images to be considered are determined from forming a set of images residing on the user device 120:2 that were captured in temporal proximity to the timestamp associated with the currently processed location-history item from step 352, such as timestamp 208:1 of digest 200:1, or otherwise in temporal proximity to the corresponding simultaneous visit represented by the proximate location determined in steps 354-360.

The exchange module 136 determines if an image was captured at a proximate location by determining the distance between the proximate location and the capture location of the image. In this computation, the location of the proximate location is taken to be the midpoint between the two locations in the proximate location. The midpoint between the pair of proximate locations is computed using variants of the planar distance approximation and the spherical distance determination techniques described above. Likewise, the distance between the midpoint of the proximate locations and the capture location of the image under consideration is determined using one or more of the planar distance approximations and the spherical distance determination techniques described above.

At step 364, the exchange module 136:2 of the other user device 120:2 compares the separation distance to a proximate image maximum separation threshold. If the separation distance is less than the maximum separation threshold (PIMSDT), then the image is considered to have been captured in proximity to that location, and processing continues at step 366, otherwise processing continues at step 362, where the next image in the set is considered. In some embodiments, the proximate image maximum distance separation threshold ranges from 100 feet to 1 mile, inclusive.

At step 366, the exchange module 136:2 of the user device 120:2 includes the image in an image cluster associated with the proximate location determined for the current comparison cycle. In some embodiments, the image cluster is associated with the midpoint determined in step 360 for the proximate locations identified using the geographic location 206:1 from digest 200:1 and the corresponding geographic location 206:2 for user device 120:2.

At step 368, the exchange module 136:2 of the user device 120:2 determines if there are more images in the image set referenced in step 362.

At step 370, the exchange module 136:2 of the user device 120:2 checks to see if there are additional location-history items in digest 200:1 to process. If there are additional location-history items, processing returns to step 352. Otherwise, processing is complete, and the images to share (proximate images) have been determined.

It is to be noted, however, that other matching techniques can be applied to determine the geographical location and time overlap and remain within the scope of the present disclosure. For example, an optimization can be applied whereby the matching of geographical locations is conducted in a hierarchical fashion (i.e starting from coarse-grained geographical location and time data, and only drilling down to finer-grained information when there is a match at the current level, thereby cutting down the amount of data shared and processed).

FIG. 3D is a flowchart illustrating the determination of candidate images to share based on facial template information included in a digest obtained from a user device, according to one or more embodiments. The flowchart of FIG. 3D expands on the processing performed in step 316 of FIG. 3B. As such, FIG. 3D describes processing the digest 200:1 received from user device 120:1 and comparing the facial templates 210:1 included in the digest 200:1 with images residing on user device 120:2. The steps performed are described from the perspective of the exchange module 136:2 of user device 120:2. In this example, user device 120:2 is considered the local user device, and user device 120:1 is considered the remote user device.

At step 380, the exchange module 136:2 of the user device 120:2 obtains the next facial template 210:1 in the digest 200:1 received from the remote user device 120:1. The facial templates 210:1 include facial templates for subjects associated with user 110:1, for example, user 110:1, subjects appearing in the image collection 150:1 residing on the user device 120:1 used by user 110:1, and/or subjects traveling with user 110:1. At step 382, the exchange module 136:2 of the user device 120:2 identifies images from the local user device 120:2 in which the subject corresponding to the facial template 210:1 appears. The digest 200:1, including the facial template 210:1, is received from user device 120:1 in step 314 of FIG. 3B.

At step 384, the exchange module 136:2 of the user device 120:2 includes the identified images in the set of images to be shared with user device 120:1, if the identified images are not already included in the set. In some embodiments, the exchange module 136:2 accesses facial templates associated with the local user device 120:2 from master facial templates 154. The master facial templates 154 may include an index linking each facial template in the master facial templates 154 to one or more images in the image collection 150 in which the corresponding subject appears, thereby enabling efficient identification of matching images.

At step 386, the exchange module 136:2 of the user device 120:2 determines whether there are additional facial templates in the digest 200:1 to process. If there are additional facial templates to process, processing continues at step 380. Otherwise, processing ends.

FIG. 4A is a graphical depiction of a user interface (digest specification 400 interface) allowing a user to specify the contents of a digest, according to one or more embodiments. The digest specification 400 interface is presented to the user 110 of a user device 120 prior to transmitting the digest 200 to another user device 120:2. In some embodiments, a default digest 200 is generated, and the digest specification 400 interface is not presented. In some embodiments, a user preference indicates when/if the digest specification 400 interface is presented. The digest 200 includes a time window 202, location history 204, facial templates 210, and request preferences 218. The digest specification 400 interface is an example of how the time window 202 and location history 204 of the digest can be specified in some embodiments. The digest specification interface 400 shows one or more geographical locations visited 402 by a user device 120 prior to the initiation of sharing. In the interface, each geographical location visited 402 includes a selection control 404 that enables the user 110 to control whether the geographical location is included in the digest 200, a location description 406, and a visitation start time 408. The use of the digest specification interface 400 is optional. In some embodiments, no digest specification interface 400 is displayed, and default information is used. In some embodiments, the default information can be configured in a configuration interface.

FIG. 4B is a graphical depiction of a user interface (image selection confirmation interface 420) allowing a user 110 to confirm the images 114 identified for sharing, according to one or more embodiments. FIG. 4B continues with the nomenclature and device roles established in FIG. 3A-3D. The image selection confirmation interface 420 can be optionally presented at the other user device 120:2 (which is sending images to user device 120:1) and/or user device 120:1 (which is receiving images from other user device 120:2). The image selection confirmation interface 420 displays a grid of candidate images 424. The user 110 is enabled to select zero or more images displayed in the grid 424.

When presented at the other user device 120:2, the image selection confirmation interface 420 controls which candidate images 114 are transmitted to user device 120:1. When presented at user device 120:1, the image selection confirmation interface 420 controls which candidate images provided by other user device 120:2 are retained at user device 120:1.

In some embodiments, the candidate images displayed in the image grid 424 are thumbnails received by the user device 120:1. Based on the image selections 422 made by user 110:1, the user device 120:1 sends the selection information back to the user device 120:2, which in turn sends the full-resolution images, which are subsequently received at user device 120:1 and retained. This embodiment is described in FIG. 3 as steps 320-324.

In some embodiments, the candidate images displayed in the image grid 424 represent full-resolution images that have already been received at the user device 120:1. Based on the image selections 422 made by user 110:1, the user device 120:1 retains the already received full-resolution images (and steps 320-324 are skipped).

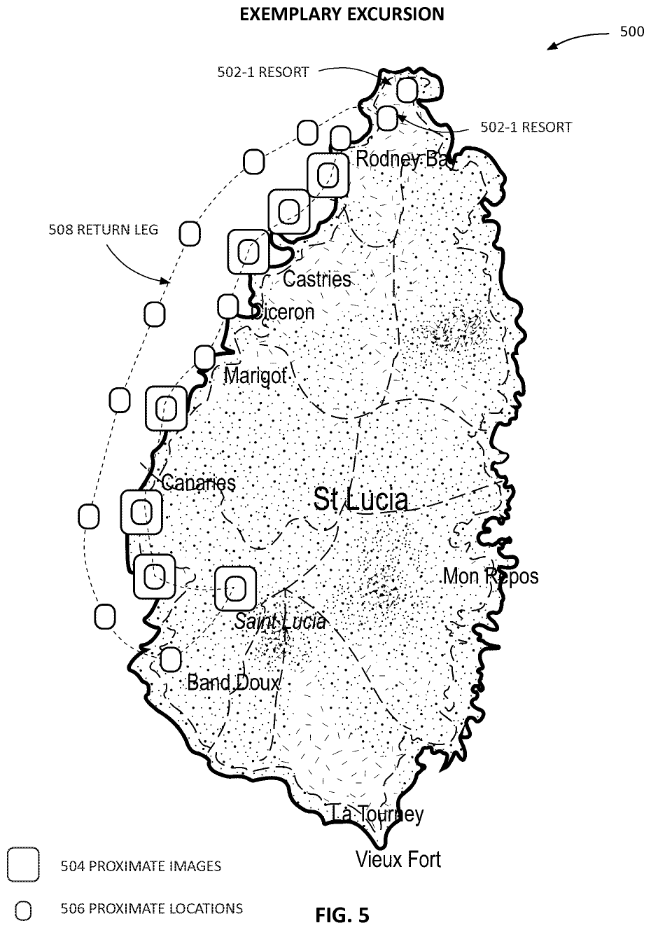

FIG. 5 is a map 500 illustrating the geographical locations visited during an exemplary excursion, according to one or more embodiments.

The map 500 is of St. Lucia Island and includes resorts 502, clusters of proximate images 504, and proximate locations 506. Each resort 502 identifies a starting location for a user 110. Each proximate location 506 indicates a location that both users 110 visited simultaneously, as determined from each user's respective digest 200 (as shown in FIG. 3C in some embodiments). Each cluster of proximate images 504 indicates one or more images captured within a threshold time of a proximate location 506 (proximate images—also determined in FIG. 3C according to some embodiments).

In our illustrative sharing scenario, users 110:1 and 110:2 are vacationing in St. Lucia. The users 110 are staying at different resorts 502 and do not know each other (and don't have each other's contact information). Both users 110 join a boat excursion that picks up participants from the users 110 respective resorts 502 and ferries them to multiple locations along the island's shoreline over the morning and into the early afternoon. Each user can be traveling with others, such as family members and/or travel companions. Throughout the excursion, users 110:1 and 110:2 capture images using their respective user devices 120, such as smartphones. The images from user 110:1 may depict: members of user 110:1's group (including user 110:1), members of user 110:2's group (including user 110:2), other excursion participants, surrounding landscapes, and points of interest (POIs), or any scene, in any combination. The same applies for the images captured by user 110:2.

At the end of the day, the participants (users 110) board the boat for the return to their respective resorts 502. Users 110:1 and 110:2 discuss the images that they captured and decide to exchange images, given they may never have another chance. Because the boat is traveling along the coastline, the users 110 do not have access to infrastructure Wi-Fi or reliable cellular networks. Using the techniques described herein, users 110:1 and 110:2 initiate the sharing process by bringing the two user devices into very close proximity (or otherwise providing a proximity gesture). The two phones exchange location-history digests 200. By comparing locations visited by user 110:1 with locations visited by user 110:2, respective exchange modules 136 on each user device 120 identify proximate locations 506 and determine respective subsets of images from each user device 120 as candidates for sharing.

In some embodiments, a user device 120 can mark outgoing candidate images 114 with a tag indicating that the candidate images 114 should not be shared with others. In some embodiments, a user device 120 can mark an outgoing candidate image 114 with contact information such that the user sharing the candidate image 114 can be notified any time that the image 114 is shared with another user device 120 (regardless of how many times and at what levels the candidate images 114 are shared).

### Process Overview

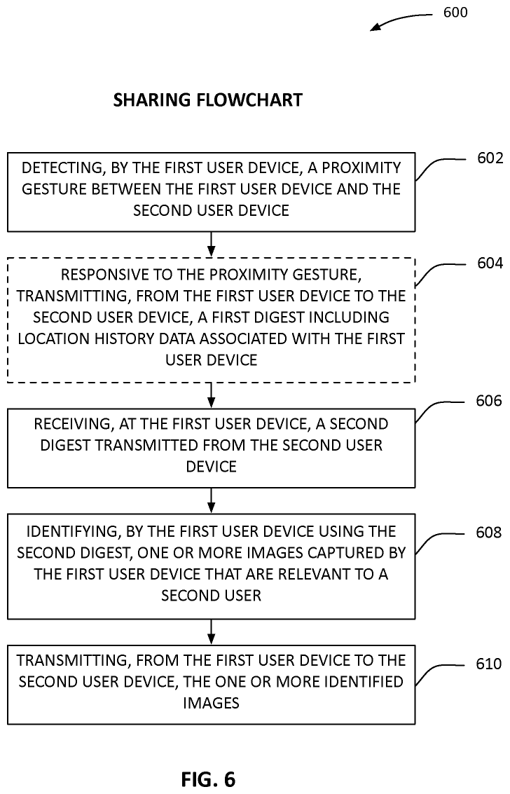

FIG. 6 is a flow diagram of method steps for sharing images according to various embodiments. Although the method steps are described in conjunction with the system of FIGS. 1-5, persons of ordinary skill in the art will understand that any system configured to perform the method steps, in any order, is within the scope of the present disclosure.

As shown in FIG. 6, method 600 begins at step 602, where the sharing module 122:1 of the first user device 120:1 detects a proximity gesture between the first user device 120:1 and the second user device 120:2. In some embodiments, the proximity gesture is generated by bringing the first user device 120:1 into geographic proximity to the second user device 120:2. For example, with NFC, the two user devices 120 need to be within a few centimeters (about an inch or two), but don't actually need to touch.

At step 604, the sharing module 122:1 of the first user device 120:1 optionally sends a first digest 200:1 to the second user device 120:2. In most instances, bidirectional sharing takes place between the first user device 120:1 and the second user device 120:2, but this is not mandatory. In some scenarios, the second user device 120:2 can elect to share candidate images 114:1 with the first user device 120:1 but not receive candidate images 114:2 from the first user device 120:1. Digests can be encrypted so that only the geographical locations 206 and/or facial templates 210 present on both user devices 120 can be decrypted.

At step 606, the sharing module 122:1 of the first user device 120:1 receives a digest 200:2 from the second user device 120:2. The digest 200:2 includes location history 204:2 and can optionally include one or more facial templates 210:2. The location history 204:2 includes timestamped 208:2 geographic locations 206:2. The facial templates 210:2 include facial templates, including a user template 212:2 for the user 110:2 and user acquaintance templates 214:2. The user acquaintance templates 214:2 can be determined from faces of subjects appearing in the image collection 150:2 of the user 110:2.

At step 608, the sharing module 122:1 of the first user device 120:1 identifies images to send to the second user device 120:2 by analyzing the second digest received in step 606. In some embodiments, such as described in FIG. 3C, the images to share are determined by determining the proximate locations 506. Those proximate locations 506 are then compared with the capture locations of images captured in temporal proximity to the time of a corresponding simultaneous visit to form the set of images to share. In some embodiments, an embedded AI module determines the images to share.

At step 610, the sharing module 122:1 of the first user device 120:1 sends the candidate images 114:2 identified for sharing to the second user device 120:2. In some embodiments, the sharing module 122:1 prompts the user 110:1 to confirm the candidate images 114:2 identified for sharing, using, for example, the user interface depicted in FIG. 4B. In some embodiments, thumbnails of the images are sent first, and full-resolution images are only sent once confirmation is received from the second user device 120:2.

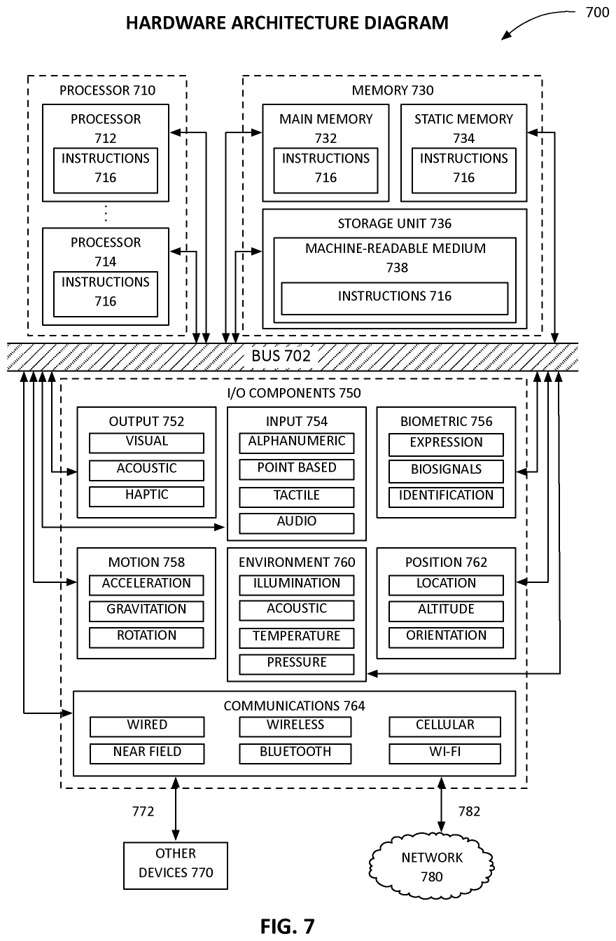

FIG. 7 is a block diagram illustrating the components of a machine 700, according to some embodiments. The machine 700 is able to read instructions from a machine-readable medium 738 (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, client, or other executable code) for causing the machine 700 to perform any one or more of the methodologies discussed herein can be executed. In alternative embodiments, the machine 700 operates as a standalone device or can be coupled (e.g., networked) to other machines 700. In a networked deployment, the machine 700 may operate as a server machine or a client machine in a server-client network environment, or as a peer machine in a peer-to-peer (or distributed) network environment. The machine 700 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), a digital picture frame, a TV, an Internet-of-Things (IOT) device, a camera, other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

In various embodiments, the machine 700 comprises processors 710, memory 730, and I/O components 750, which can be configured to communicate with each other via a bus 702. In an example embodiment, the processors 710 (e.g., a central processing unit (CPU), a reduced instruction set computing (RISC) processor, a complex instruction set computing (CISC) processor, a graphics processing unit (GPU), a tensor processing unit (TPU), a language processing unit (LPU), a neural processing unit (NPU), a digital signal processor (DSP), an application specific integrated circuit (ASIC), a radio-frequency integrated circuit (RFIC), another processor, or any suitable combination thereof) include, for example, a processor 712 and a processor 714 that may execute the instructions 716. The term “processor” is intended to include multi-core processors 710 that may comprise two or more independent processors 712, 714 (also referred to as “cores”) that can execute instructions 716 contemporaneously. Although FIG. 7 shows multiple processors 710, the machine 700 may include a single processor 710 with a single core, a single processor 710 with multiple cores (e.g., a multi-core processor 710), multiple processors 712, 714 with a single core, multiple processors 710, 712 with multiples cores, or any combination thereof.

The memory 730 comprises a main memory 732, a static memory 734, and a storage unit 736 accessible to the processors 710 via the bus 702, according to some embodiments. The storage unit 736 can include a machine-readable medium 738 on which are stored the instructions 716 embodying any one or more of the methodologies or functions described herein. The instructions 716 can also reside, completely or at least partially, within the main memory 732, within the static memory 734, within at least one of the processors 710 (e.g., within the processor's cache memory), or any suitable combination thereof, during execution thereof by the machine 700. Accordingly, in various embodiments, the main memory 732, the static memory 734, and the processors 710 are considered machine-readable medium 738.

As used herein, the term “memory” refers to a machine-readable medium 738 able to store data temporarily or permanently and may be taken to include, but not be limited to, random-access memory (RAM), read-only memory (ROM), buffer memory, flash memory, and cache memory. While the machine-readable medium 738 is shown, in an example embodiment, to be a single medium, the term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions 716, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 750 include a wide variety of components to receive input, provide output, produce output, transmit information, exchange information, capture measurements, and so on. In general, it will be appreciated that the I/O components 750 can include many other components that are not shown in FIG. 7. Likewise, not all machines will include all I/O components 750 shown in this exemplary embodiment. The I/O components 750 are grouped according to functionality merely for simplifying the following discussion, and the grouping is in no way limiting. In various example embodiments, the I/O components 750 include output components 752 and input components 754. The output components 752 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 754 include alphanumeric input components (e.g., a keyboard, a touch screen configured to receive alphanumeric input, a image-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 750 include biometric components 756, motion components 758, environmental components 760, position components 762, among a wide array of other components. For example, the biometric components 756 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 include acceleration sensor components (e.g., accelerometer), gravitation sensor components, rotation sensor components (e.g., gyroscope), and so forth. The environmental components 760 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 762 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 750 may include communication components 764 operable to couple the machine 700 to other devices 770 and networks 780 or via a coupling 772 and a coupling 782, respectively. For example, the communication components 764 include a network interface component or another suitable device to interface with the network 780. In further examples, communication components 764 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 770 may be another machine 700 or any of a wide variety of peripheral devices (e.g., a peripheral device coupled via a Universal Serial Bus (USB)).

Moreover, in some embodiments, the communication components 764 detect identifiers or include components operable to detect identifiers. For example, the communication components 764 include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS):2D bar codes, and other optical codes), acoustic detection components (e.g., microphones to identify tagged audio signals), or any suitable combination thereof. In addition, a variety of information can be derived via the communication components 764, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 780 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 780 or a portion of the network 780 may include a wireless or cellular network, and the coupling may be a Code Division Multiple Access (CDMA) connection, a Global System for Mobile communications (GSM) connection, or another type of cellular or wireless coupling. In this example, the coupling 782 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 716 are transmitted or received over the network 780 using a transmission medium via a network interface device (e.g., a network interface component included in the communication components 764) and utilizing any one of a number of well-known transfer protocols (e.g., Hypertext Transfer Protocol (HTTP)). Similarly, in other example embodiments, the instructions 716 are transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

Furthermore, the machine-readable medium 738 is non-transitory (not having any transitory signals) in that it does not embody a propagating signal. However, labeling the machine-readable medium 738 “non-transitory” should not be construed to mean that the medium is incapable of movement; the machine-readable medium 738 should be considered as being transportable from one physical location to another. Additionally, since the machine-readable medium 738 is tangible, the machine-readable medium 738 may be considered to be a machine-readable device.

The user device 120 is an example of machine 700. The user device 120 may, in some embodiments, have more or fewer features than machine 700.

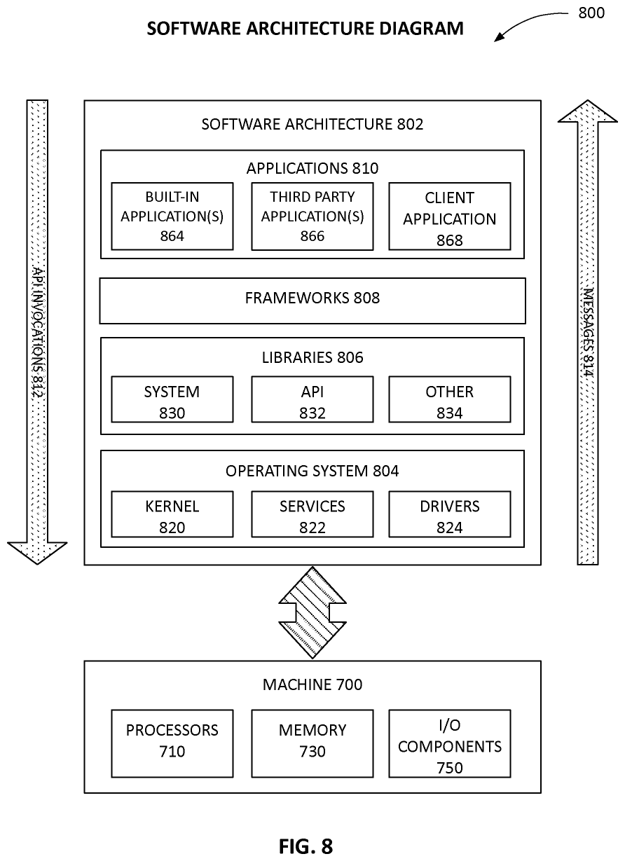

FIG. 8 is a block diagram illustrating an exemplary software architecture diagram 800, which can be employed on any one or more of the machines 700 described above. FIG. 8 is merely a non-limiting example of a software architecture, and it will be appreciated that many other architectures can be implemented to facilitate the functionality described herein. Other embodiments may include additional elements not shown in FIG. 8 and not all embodiments will include all of the elements of FIG. 8. In various embodiments, the software architecture 802 is implemented by hardware such as machine 700 of FIG. 7 that includes processors 710, memory 730, and I/O components 750. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke application programming interface (API) calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth. In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various graphic user interface (GUI) functions, high-level resource management, high-level location services, and so forth. The frameworks 808 can provide a broad spectrum of other APIs that can be utilized by the applications 810, some of which may be specific to a particular operating system 804 or platform.

According to some embodiments, the applications 810 are programs that execute functions defined in the programs. The applications 810 can take different forms, including built-in applications 864, third-party applications 866, and client applications 868. built-in applications 864 are characterized by being distributed with the operating system. Third-party applications 866 can be created by developers other than the developer of the operating system. Client applications 868 typically communicate with a server device over the network to perform a function. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application 810 developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

In sum, techniques are disclosed for the sharing of images over an ad-hoc network between two user devices. The sharing process begins when a sharing module of a first user device detects a proximity gesture. A proximity gesture can simply be the physical proximity of two user devices. Upon detecting the proximity gesture, the sharing module on the first user device participates in establishing an ad hoc network between the two devices. The ad hoc network permits the transmission of the image payload over a high-bandwidth wireless channel, such as Wi-Fi Direct. The first user device generates and sends a first digest to the second user device while receiving a second digest from the second user device. Each digest includes a location history and, optionally, a facial index. The location history includes timestamped geographic locations. The facial index includes facial templates, including a user template and user-acquaintance templates. The digests can be encrypted by the sharing module such that only the geographical locations and facial templates present on both user devices can be decrypted. Once received at the first user device, the second digest is analyzed to determine the images to share with the second user device by determining simultaneously visited geographic locations from the location history. Those simultaneously visited geographic locations are then compared with the capture locations of images in the image collection of the first user device captured in temporal proximity to the time of the corresponding simultaneous visit to form the set of images to share. In some embodiments, the sharing module uses an embedded AI module to determine the images to share. The images to share are then sent to the second user device. The sharing module can confirm the images to share with the second user device by prompting the first user. The sharing module of the second user device can confirm the images to retain at the second user device by prompting the second user. Shared images can be sent in thumbnail form initially, followed by the full-resolution images after confirmation by the receiving user device.

At least one technical advantage of the disclosed techniques relative to the prior art is that the disclosed techniques provide mechanisms for sharing images without an established social connection, a centralized service, or manual file selection and exchange. Another technical advantage of the disclosed techniques includes mechanisms for privacy preservation, whereby encryption digest information is shared between devices, and the receiving devices can decrypt only the portions to which the receiving device already has access.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method of operating a first user device to exchange images between the first user device and a second user device, the method comprising:
detecting, by the first user device, a proximity gesture between the first user device and the second user device;
responsive to the proximity gesture:
transmitting, from the first user device to the second user device, a first digest including location history associated with the first user device;
receiving, at the first user device, a second digest including location history associated with the second user device transmitted from the second user device;
identifying, by the first user device using the second digest, one or more images captured by the first user device based on the second digest; and
transmitting, from the first user device to the second user device, the one or more images.

2. The method of claim 1, wherein transmitting the first digest comprises:
building the first digest based on the location history associated with the first user device, the location history including a plurality of geographic locations visited, each of the plurality of geographic locations being timestamped with a time of visit.

3. The method of claim 2, wherein building the first digest comprises:
encrypting the first digest such that the second user device is only able to access timestamped geographic locations occurring in both the first digest and the second digest.

4. The method of claim 1, wherein transmitting the first digest comprises:
building the first digest based on one or more of:
a facial template of a user of the first user device,
one or more facial templates of one or more other subjects appearing in a collection of images residing at the first user device,
one or more other embeddings.

5. The method of claim 4, wherein building the first digest comprises:
encrypting the first digest such that the second user device is only able to access facial templates included in both the first digest and the second digest.

6. The method of claim 1, wherein transmitting the first digest comprises:
participating in establishing an ad hoc network between the first user device and the second user device using information exchanged using near field communications.

7. The method of claim 1, wherein response to transmitting the first digest from the first user device to the second user device, the method further comprises:
receiving second one or more images identified by the second user device based on the first digest.

8. The method of claim 7 further comprising:
in response to receiving the second one or more images identified by the second user device based on the first digest:
prompting a user of the first user device to confirm an image of the second one or more images identified by the second user device based on the first digest.

9. The method of claim 8, wherein receiving the second one or more images identified by the second user device further comprises:
receiving thumbnails of the one or more images identified by the second user device;
identifying an image of the one or more images to retain at the first user device based on the thumbnails; and
sending information identifying the image to retain at the first user device.

10. The method of claim 9, wherein identifying the image to retain at the first user device further comprises:
receiving user input from a first user of the first user device; and
identifying the image to retain based on the user input.

11. The method of claim 9, wherein identifying the image to retain at the first user device further comprises:
instructing an AI model to identify the image based on one or more of quality, uniqueness, and size.

12. One or more non-transitory computer-readable media storing instructions that, when executed by one or more processors, cause the one or more processors to perform the steps of:
detecting, by a first user device, a proximity gesture between the first user device and a second user device;
responsive to the proximity gesture:
receiving, at the first user device, a second digest transmitted from the second user device;
determining, by the first user device using the second digest, one or more images captured by the first user device based on the second digest; and
sending, from the first user device to the second user device, the one or more images.

13. The one or more non-transitory computer-readable media of claim 12, wherein detecting the proximity gesture comprises determining that the second user device is in geographical proximity to the first user device.

14. The one or more non-transitory computer-readable media of claim 12, where in response to detecting the proximity gesture comprising:
exchanging metadata sufficient to establish trust and enable discovery with the second user device via near-field communication.

15. The one or more non-transitory computer-readable media of claim 12, wherein determining the one or more images comprises:
determining from a first digest and the second digest a proximate location, wherein the proximate location is a geographic location simultaneously visited by both the first user device and the second user device;
determining one or more proximate images, wherein a proximate image is an image captured by the first user device in geographical proximity to the proximate location, and in temporal proximity to a time of the simultaneous visit.

16. The one or more non-transitory computer-readable media of claim 12, wherein determining the one or more images comprises:
comparing a first digest and the second digest to determine one or more faces in the second digest that are present in the first digest.

17. The one or more non-transitory computer-readable media of claim 12, wherein sending the one or more images comprises:
prompting a user of the first user device to confirm the one or more images to transmit from the first user device to the second user device.

18. The one or more non-transitory computer-readable media of claim 12, wherein sending the one or more images comprises:
ordering the one or more images to be transmitted based on preferences received from the second user device.

19. The one or more non-transitory computer-readable media of claim 12, wherein sending the one or more images comprises:
including information identifying whether the one or more images should be reshared by the second user device.

20. The one or more non-transitory computer-readable media of claim 18, wherein sending the one or more images comprises:
including contact information for a first user of the first user device; and
providing notification to the first user of the first user device when an image of the one or more images is reshared.

21. A first user device comprising:
a memory storing an exchange module;
a network interface operable to perform the steps of:
detecting, by the first user device, a proximity gesture between the first user device and a second user device;
a processor coupled to the memory and the network interface that executes the exchange module to perform the steps of:
transmitting, from the first user device to the second user device, a first digest including location history data associated with the first user device;
receiving, at the first user device, a second digest including location history associated with the second user device transmitted from the second user device;
identifying, by the first user device using the second digest, one or more media items captured by the first user device matching one or more parameters of the second digest; and
transmitting, from the first user device to the second user device, the one or more media items.

22. The first user device of claim 21, wherein the media items are one of audio items, video items, and text items, wherein the media items are tagged with capture time and capture location.

23. The first user device of claim 21, wherein the first user device and the second user device are both mobile devices.
